(19) United States
(12) Patent Application Publication
(10) Pub. No.: US 2005/0114469 A1
(43) Pub. Date: May 26, 2005

(54) Information processing apparatus with a network service function and method of providing network services

(76) Inventors: Manabu Nakamura, Kanagawa (JP); Kohji Fujinaga, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/938,717

(22) Filed: Sep. 13, 2004

(30) Foreign Application Priority Data
Sep. 16, 2003 (JP) 2003-323538
Sep. 16, 2003 (JP) 2003-323539

(51) Int. Cl. G06F 15/16

(52) U.S. Cl. 709/218

(57) ABSTRACT

An information processing apparatus is disclosed that has a network service function that receives incoming requests through a plurality of ports by a protocol daemon, and dispatches processing of each incoming request to one of applications identified by information included in the incoming request. The information processing apparatus includes a request processing part that, when each incoming request is received, obtains a port corresponding to the identified application, determines whether the obtained port matches the port of the incoming request, and dispatches the processing of the incoming request to the identified application when the obtained port matches the port of the incoming request.

### BACKGROUND OF THE INVENTION

1. Field of the Invention

The present invention relates to an information processing apparatus with a network service function and a method of providing network services.

2. Description of the Related Art

In recent years, so-called multi-function apparatuses, which are image-forming apparatuses including the functions of a printer, a copier, a facsimile machine, and a scanner in a single housing, have been provided. These image-forming apparatuses are connectable to an intranet inside the office, and have the function of providing a variety of network services such as a Web service.

In the above-described conventional image-forming apparatuses with a network service function, a server program called an HTTP daemon (HTTPd) processes a request from a client such as a Web browser. The HTTP daemon performs processing from the dispatching (assigning) of processing to a corresponding Web application in accordance with a URL path included in the request to the returning of the response of the processing to the HTTP client. In general, the server program called HTTPd often means software identified by a single port number (for instance, 80) and providing a Web service independently, such as Apache, famous Web server freeware. In the field of image-forming apparatuses, however, HTTPd is used in the above-described sense. This is because a wider range of protocols than in common network services should be handled in order to satisfy multiple functions required of the image-forming apparatuses.

A more detailed description is given below of the operation of the HTTP daemon in a conventional image-forming apparatus with a network service function.

First, at the time of activation, the HTTP daemon opens all ports assigned fixedly to corresponding services, such as port 80 for normal HTTP communications, port 443 for HTTP communications using SSL (Secure Sockets Layer), and port 631 for IPP (Internet Printing Protocol) peculiar to image-forming apparatuses.

Next, the HTTP daemon checks a URL path included in an HTTP request received at any of the ports it has opened, and dispatches processing to a corresponding Web application. For instance, in the case where the URL path of Web application “Websys” is defined as “/websys/aaa,” if the URL path “/websys/aaa” is specified in the HTTP request, the HTTP daemon dispatches processing to Web application “Websys.” At this point, a port number is not verified in particular. Any HTTP request is dispatched to the corresponding Web application irrespective of a port number at which the HTTP request is received as long as the HTTP request passes a URL path check. If there is no corresponding Web application, an error is returned.

Thereafter, the Web application performs processing, and when an HTML, XML, or TEXT document is generated as a result, the HTTP daemon returns the result to the requesting HTTP client.

On the other hand, Published Japanese Translation of PCT International Application No. 2002-523924 discloses prior-art techniques for routing messages to addressable portions (for instance, processes) within an apparatus using port numbers.

Further, Japanese Laid-Open Patent Application No. 2000-250755 discloses prior-art techniques pertaining to a method of easily developing software for a specific platform without a designer describing details.

The operation of the HTTP daemon in the conventional image-forming apparatus with a network service function, which is characteristically different from that in a common Web server, is accompanied by the following problems.

First, any HTTP request is dispatched to a corresponding Web application irrespective of the port number at which the HTTP request is received as long as the HTTP request passes a URL path check. Accordingly, an HTTP access from a port number that the Web application does not expect to receive access from may be received, thus causing a security problem (a problem in that this may become a security hole).

Further, a port corresponding to an application used exclusively by a particular contract user, such as an application called NRS (New Remote Service: a remote diagnosis service) may be opened. Illegal access may be made through such an open port that is not in actual use, thus causing a security problem (a problem in that this may become a security hole). In the image-forming apparatus, besides the above-described case of NRS, the opening of a port not in actual use may be caused in many other cases such as when a port for a facsimile application is opened without a facsimile board being mounted.

Further, since a predetermined port number is fixedly assigned to an application, it is impossible for the application to perform communications using another port number unique thereto. This causes a problem of limited flexibility on the Web application side.

The above-described problems hold true not only for the HTTP daemon but also for protocol daemons handling other network services, such as an FTP daemon (ftpd).

On the other hand, it is more common nowadays to provide a development environment called SDK (Software Development Kit) in order to promote application development by a third party (such as an external software house). For instance, creation of an SDK application operable on an image-forming apparatus, such as “document management software for a specific line of business,” is assumed.

When such an SDK application is provided with a network service function, there arises a requirement to meet a need for freedom in selection of a port to use. However, it is impossible to meet such a need by the mechanism of the protocol daemon of the conventional image-forming apparatus.

Further, allowing execution of an SDK application manufactured by a third party inevitably requires more deliberation on security. This makes it important to solve the above-described problems of illegal access through an unexpected port number and the opening of an application port not in use.

### SUMMARY OF THE INVENTION

Accordingly, it is a general object of the present invention to provide an information processing apparatus with a network service function and a method of providing network services in which the above-described disadvantages are eliminated.

A more specific object of the present invention is to provide an information processing apparatus with a network service function and a method of providing network services that can improve security in port access and increase flexibility in port selection on the application side.

Another more specific object of the present invention is to provide an information processing apparatus with a network service function and a method of providing network services that makes it possible to select a port to be used for a network service by an SDK application and increase security in port access.

One or more of the above objects of the present invention are achieved by an information processing apparatus having a network service function that receives incoming requests through a plurality of ports by a protocol daemon, and dispatches processing of each incoming request to one of applications identified by information included in the incoming request, the information processing apparatus including: a request processing part configured to, when each incoming request is received, obtain a port corresponding to the identified application, determine whether the obtained port matches a port of the incoming request, and dispatch the processing of the incoming request to the identified application when the obtained port matches the port of the incoming request.

One or more of the above objects of the present invention are also achieved by a network service providing method of an information processing apparatus that receives incoming requests through a plurality of ports by a protocol daemon, and dispatches processing of each incoming request to one of applications identified by information included in the incoming request, the network service providing method including the steps of: (a) recording the applications and the ports so that each application is correlated with a corresponding one or more of the ports for receiving the incoming request to the application; and (b) when each incoming request is received, obtaining the one or more of the ports corresponding to the identified application, determining whether one of the obtained port matches a port of the incoming request, and dispatching the processing of the incoming request to the identified application when the one of the obtained port matches the port of the incoming request.

According to the above-described apparatus and method, a request from a port from which an application does not expect to receive a request is prevented from being passed to the application. As a result, security can be improved.

One or more of the above objects of the present invention are also achieved by an information processing apparatus having a network service function that receives incoming requests through a plurality of ports by a protocol daemon, and dispatches processing of each incoming request to one of applications identified by information included in the incoming request, the information processing apparatus including: a port recording part configured to record a new port based on a port recording request from any of the applications, and record the applications and the ports so that each application is correlated with a corresponding one or more of the ports for receiving the incoming request to the application; and a request processing part configured to, when each incoming request is received, obtain the one or more of the ports corresponding to the identified application, determine whether one of the obtained ports matches a port of the incoming request, and dispatch the processing of the incoming request to the identified application when the one of the obtained ports matches the port of the request.

One or more of the above objects of the present invention are also achieved by a network service providing method of an information processing apparatus that receives incoming requests through a plurality of ports by a protocol daemon, and dispatches processing of each incoming request to one of applications identified by information included in the incoming request, the network service providing method including the steps of: (a) recording a new port based on a port recording request from any of the applications, and recording the applications and the ports so that each application is correlated with a corresponding one or more of the ports for receiving the incoming request to the application; and (b) when each incoming request is received, obtaining the one or more of the ports corresponding to the identified application, determining whether one of the obtained ports matches a port of the incoming request, and dispatching the processing of the incoming request to the identified application when the one of the obtained ports matches the port of the incoming request.

According to the above-described apparatus and method, it is possible to record a port that an SDK application uses in a network service. Further, a request from a port from which an application does not expect to receive a request is prevented from being passed to the application. As a result, security can be improved. Further, a port receiving processing is recorded application by application. Therefore, there is more flexibility in port selection on the application side.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a functional configuration of an image-forming apparatus according to a first embodiment of the present invention;

FIG. 2 is a block diagram showing a hardware configuration of the image-forming apparatus according to the first embodiment of the present invention;

FIG. 3 is a block diagram showing a functional configuration of a network service function-related part of the image-forming apparatus according to the first embodiment of the present invention;

FIG. 4 is a sequence diagram showing a procedure for a port recording operation according to the first embodiment of the present invention;

FIG. 5 is a diagram showing the relationship between a request from an application and data to be recorded in tables in the port recording operation according to the first embodiment of the present invention;

FIG. 6 is a sequence diagram showing an operation procedure at the time of request reception according to the first embodiment of the present invention;

FIG. 7 is a diagram showing the relationship between a request and table contents in a port verifying operation at the time of the request reception according to the first embodiment of the present invention;

FIG. 8 is a block diagram showing a functional configuration of an image-forming apparatus according to a second embodiment of the present invention;

FIG. 9 is a block diagram showing a hardware configuration of the image-forming apparatus according to the second embodiment of the present invention;

FIG. 10 is a block diagram showing a functional configuration of a network service function-related part of the image-forming apparatus according to the second embodiment of the present invention;

FIG. 11 is a sequence diagram showing a procedure for a port identifier and port number recording operation according to the second embodiment of the present invention;

FIG. 12 is a diagram showing the relationship between a request from an application and data to be recorded in a table in the port identifier and port number recording operation according to the second embodiment of the present invention;

FIG. 13 is a diagram showing an example message on an operations panel in the port identifier and port number recording operation according to the second embodiment of the present invention;

FIG. 14 is a diagram showing another example message on the operations panel in the port identifier and port number recording operation according to the second embodiment of the present invention;

FIG. 15 is a sequence diagram showing a procedure for an application ID/URL path and application ID/port identifier recording operation according to the second embodiment of the present invention;

FIG. 16 is a diagram showing the relationship between a request from an application and data to be recorded in tables in the application ID/URL path and application ID/port identifier recording operation according to the second embodiment of the present invention;

FIG. 17 is a diagram showing an example message on the operations panel in recording of an application ID and a URL path according to the second embodiment of the present invention;

FIG. 18 is a diagram showing another example message on the operations panel in the recording of the application ID and the URL path according to the second embodiment of the present invention;

FIG. 19 is a sequence diagram showing an operation procedure at the time of request reception according to the second embodiment of the present invention; and

FIG. 20 is a diagram showing the relationship between a request and table contents in a port verifying operation at the time of the request reception according to the second embodiment of the present invention.

### DETAILED DESCRIPTION OF THE PREFERRED EMBODIMENTS

A description is given below, with reference to the accompanying drawings, of embodiments of the present invention.

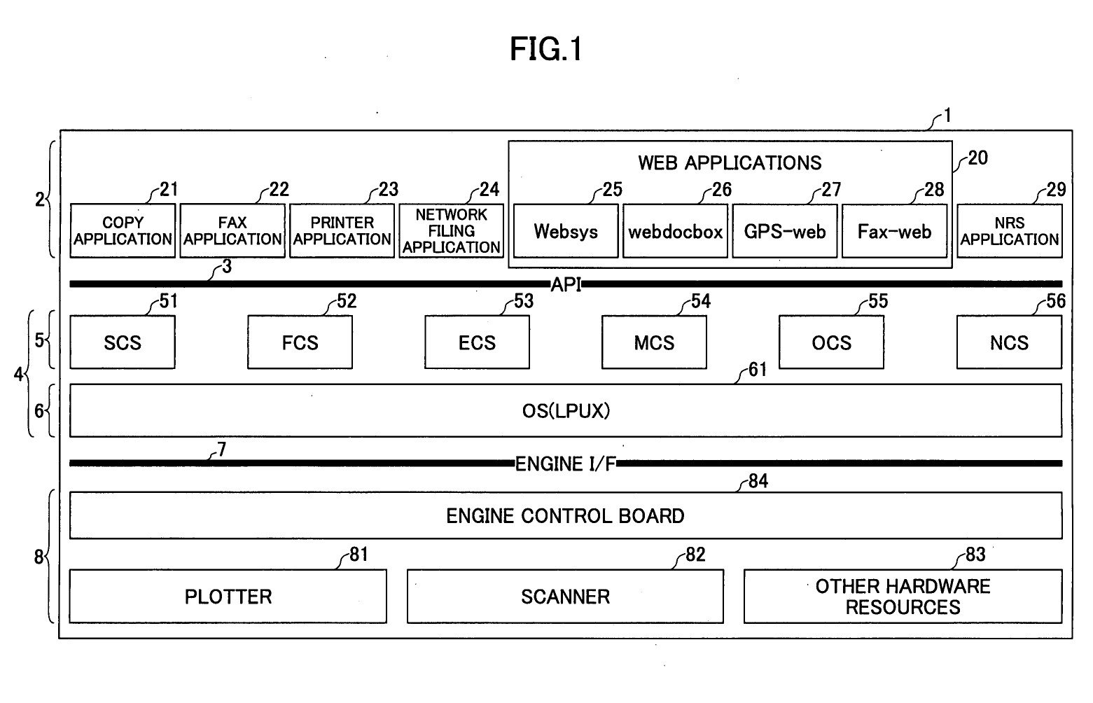

FIG. 1 is a block diagram showing a functional configuration of an image-forming apparatus (information processing apparatus) 1 according to a first embodiment of the present invention.

Referring to FIG. 1, the image-forming apparatus 1 includes an application layer 2, a platform layer 4, and an engine part 8. An interface 3 is an interface (API: Application Programming Interface) with the application layer 2 provided by the platform layer 4. An interface 7 is an engine I/F between the platform layer 4 and the engine part 8.

The application layer 2 is a group of software programs performing processing individually in the image-forming apparatus 1. The application layer 2 includes a copy application 21 that is an application for copying, a facsimile (FAX) application 22 that is an application for facsimile, a printer application 23 that is an application for a printer, and a network filing application 24 that is an application for network filing that exchanges files via a network. Web applications 20 are a group of applications performing Web services under HTTP. The Web applications 20 include a Web application (Websys) 25, a Web application (webdocbox) 26, a Web application (GPS-web) 27, and a Web application (Fax-web) 28. The Web application (Websys) 25 makes it possible to view the state of the apparatus 1 and provide network settings in the apparatus 1 using a browser. The Web application (webdocbox) 26 receives and manages documents using the browser and the function of the network filing application 24. The Web application (GPS-web) 27 displays the job history (spooling state) of the printer. The Web application (Fax-web) 28 makes it possible to view the initial settings and the communications management report (communications history) of a facsimile machine in a table format.

As described above in the prior-art section, an NRS application 29 provides a remote diagnosis service called NRS to a particular contract user.

Although not graphically represented, a library (a platform) for providing common functions to the applications so as to facilitate software development is suitably provided between the applications and the interface 3.

The platform layer 4 is a group of software programs providing common service functions to the applications 21 through 29 of the application layer 2 via the interface 3. The platform layer 4 includes a service layer 5 and an OS (Operating System) layer 6. The service layer 5 includes a system control service (SCS) 51, a facsimile control service (FCS) 52, an engine control service (ECS) 53, a memory control service (MCS) 54, an operations panel control service (OCS) 55, and a network control service (NCS) 56. The SCS 51 has the functions of application management, operations part control, system screen display, LED display, resource management, and interrupt control. The FCS 52 provides the API of a facsimile function. The ECS 53 controls the engine part 8. The MCS 54 performs memory control. The OCS 55 controls an operations part (operations panel) that serves as an interface with an operator. The NCS 56 provides commonly usable services to applications requiring network I/O. The OS layer 6 includes an OS (LPUX) 61.

The engine part 8 includes engines such as a plotter 81, a scanner 82, and other hardware resources 83. Further, the engine part 8 includes an engine control board 84 controlling the engines.

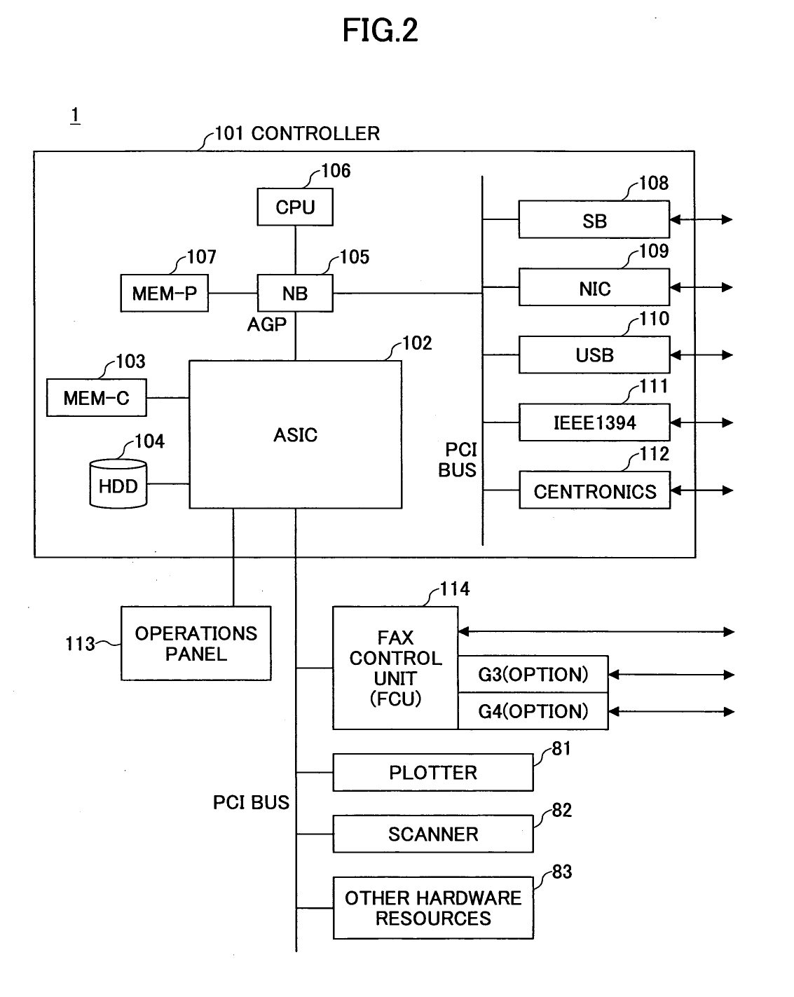

FIG. 2 is a block diagram showing a hardware configuration of the image-forming apparatus 1.

Referring to FIG. 2, the image-forming apparatus 1 includes a controller 101, an operations panel 113, a facsimile control unit 114, the plotter 81, the scanner 82, and the other hardware resources 83, which are electrically connected. The controller 101 performs control operations in the image-forming apparatus 1.

In the controller 101, a CPU 106 that is an IC for general control is connected via an NB (Northbridge) 105 serving as a bridge to an ASIC (Application Specific Integrated Circuit) 102 that is an IC for image processing. An SB (Southbridge) 108 that is a bridge for connecting peripheral devices, an NIC (Network Interface Card) 109 controlling network communications, a USB (Universal Serial Bus) 110 providing a USB interface, an IEEE 1394 device 111 providing an IEEE 1394 interface, and a Centronics device 112 providing a Centronics interface are connected to the PCI BUS of the NB 105. A MEM-C 103 as a storage unit and an HDD (Hard Disk Drive) 104 are connected to the ASIC 102, and a MEM-P 107 as a storage unit is connected to the NB 105.

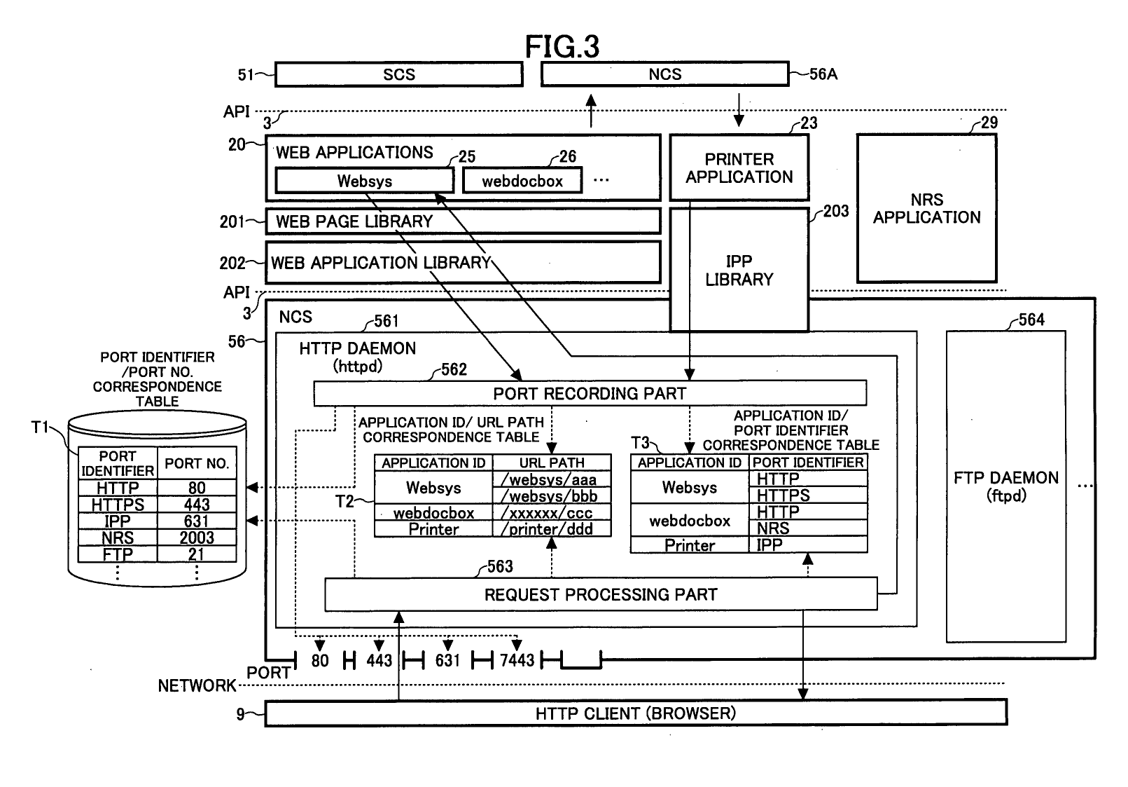

FIG. 3 is a block diagram showing a functional configuration of a network service function-related part of the image-forming apparatus 1.

In FIG. 3, the NCS 56 is identical to that in the service layer 5 in FIG. 1, but only its internal structure related to the function of the present invention is shown. The other structure of the NCS 56 is shown separately at the top of FIG. 3 as an NCS 56A, which is integrated with the NCS 56.

The Web applications 20 including the Web application (Websys) 25 and the Web application (webdocbox) 26 are provided to the NCS 56 via the interface 3 with a Web page library 201 and a Web application library 202 being provided between the Web applications 20 and the NCS 56. Further, the NRS application 29 is provided to the NCS 56 via the interface 3.

The NCS 56 includes an HTTP daemon 561 performing HTTP-related processing and an FTP daemon 564 performing FTP-related processing. The printer application 23 is provided to the HTTP daemon 561 via an IPP library 203. The IPP library 203 is provided to support IPP for printing using HTTP. A job is passed directly from the HTTP daemon 561 to the printer application 23 via the IPP library 203.

An HTTP client 9 issues a request and receives a response via a network. Normally, the HTTP client 9 is a Web browser that operates on a personal computer.

Next, a description is given of the internal structure of the HTTP daemon 561. The HTTP daemon 561 includes a port recording part 562, a request processing part 563, an application ID and URL path correspondence table T2, and an application ID and port identifier correspondence table T3. The port recording part 562 records ports receiving processing so that each port is correlated with a corresponding one of the applications, such as the application 23, 25, 26, or 29. The request processing part 563, when receiving a request from the HTTP client 9 via a network, obtains a port corresponding to an application (corresponding to the request), and determines whether the obtained port matches the port of the request. The request processing part 563 dispatches (processing of) the request to the application only when the obtained port matches the port of the request. The application ID and URL path correspondence table T2 manages application IDs identifying the applications and URL paths by correlating the application IDs with their corresponding URL paths. The application ID and port identifier correspondence table T3 manages the application IDs and port identifiers by correlating the application IDs with their corresponding port identifiers.

If the HTTP request is, for instance, “http://xxx.xxx.xxx.xxx/web/user/ja/websys/webArch/mainFrame.cgi,” the URL path means a portion of the HTTP request after a host “xxx.xxx.xxx.xxx” up to the end, “web/user/ja/websys/webArch/mainFrame.cgi.” A “web” portion equivalent to one layer subsequent to the host “xxx.xxx.xxx.xxx” is referred to as an “application path.”

The application ID and URL path correspondence table T2 and the application ID and port identifier correspondence table T3 are provided in a memory managed by the HTTP daemon 561. This is because the data of the tables T2 and T3 are not used by the other processes and proper management of the data is required to ensure security. In a state immediately after activation of the image-forming apparatus 1, no data is recorded in the application ID and URL path correspondence table T2 and the application ID and port identifier correspondence table T3. Data is recorded therein by the subsequent operation of the port recording part 562.

On the other hand, a port identifier and port number correspondence table T1 managing the port identifiers and actual port numbers by correlating the port identifiers with their corresponding actual port numbers is provided external to the NCS 56. The port identifier and port number correspondence table T1 is stored in, for instance, a hard disk unit as a file. After activation of the image-forming apparatus 1, the port identifier and port number correspondence table T1 is copied into a memory and used. This is because the port identifier and port number correspondence table T1 merely shows the correspondence between the port identifiers and the port numbers and the data of the table T1 may be referred to by other processes such as the FTP daemon 564. The port identifiers and the port numbers are pre-recorded in the port identifier and port number correspondence table T1 by, for instance, a manager.

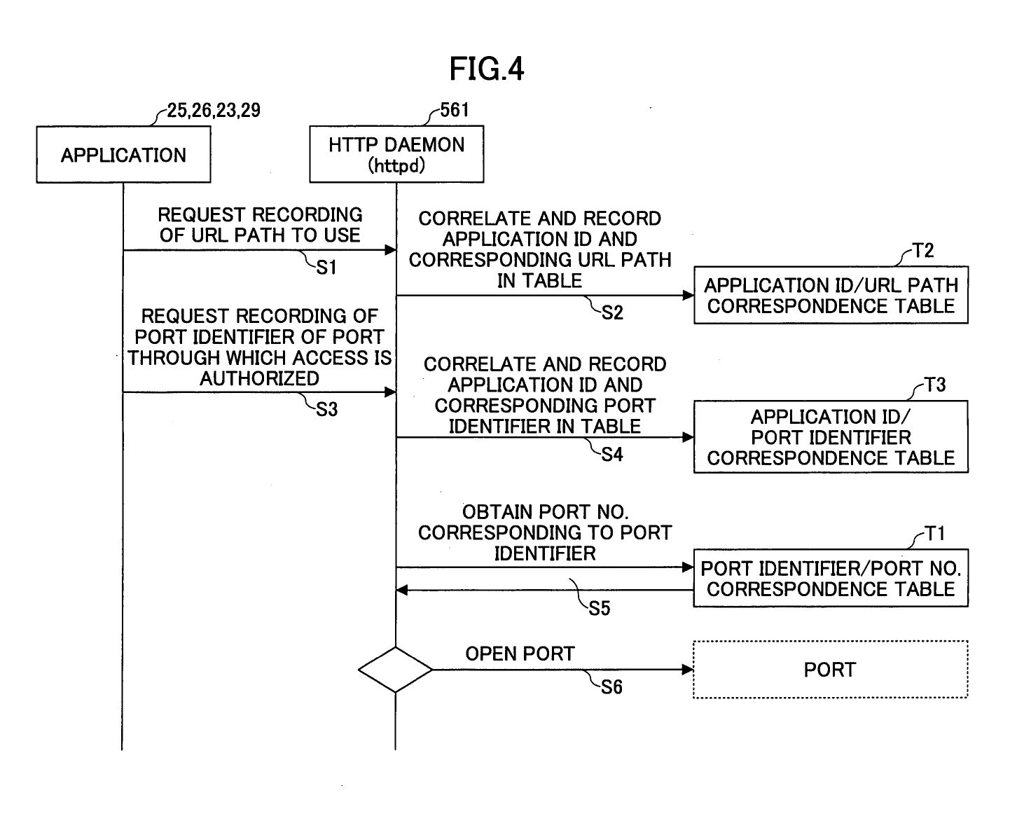

FIG. 4 is a sequence diagram showing a procedure for a port recording operation.

A description is given below, with reference to FIG. 4, of the port recording operation.

First, in step S1 of FIG. 4, at any time point after activation of the image-forming apparatus 1, one of the applications, such as the application 23, 25, 26, or 29, requests the HTTP daemon 561 to record a URL path to be used by the application. Then, in step S2, the port recording part 562 of the HTTP daemon 561 records an application ID identifying the requesting application and the specified URL path in the application ID and URL path correspondence table T2, correlating the application ID and the specified URL path with each other.

Next, in step S3, the application requests the HTTP daemon 561 to record a port identifier corresponding to a port through which the application authorizes a request to access the application. Then, in step S4, the port recording part 562 of the HTTP daemon 561 records the application ID identifying the requesting application and the specified port identifier in the application ID and port identifier correspondence table T3, correlating the application ID and the specified port identifier with each other.

Next, in step S5, the port recording part 562 of the HTTP daemon 561 refers to the port identifier and port number correspondence table T1, and obtains the port number corresponding to the recorded port identifier. Then, in step S6, the port recording part 562 determines whether the port of the port number is open, and if the port is not open (that is, closed), the port recording part 562 dynamically opens the port.

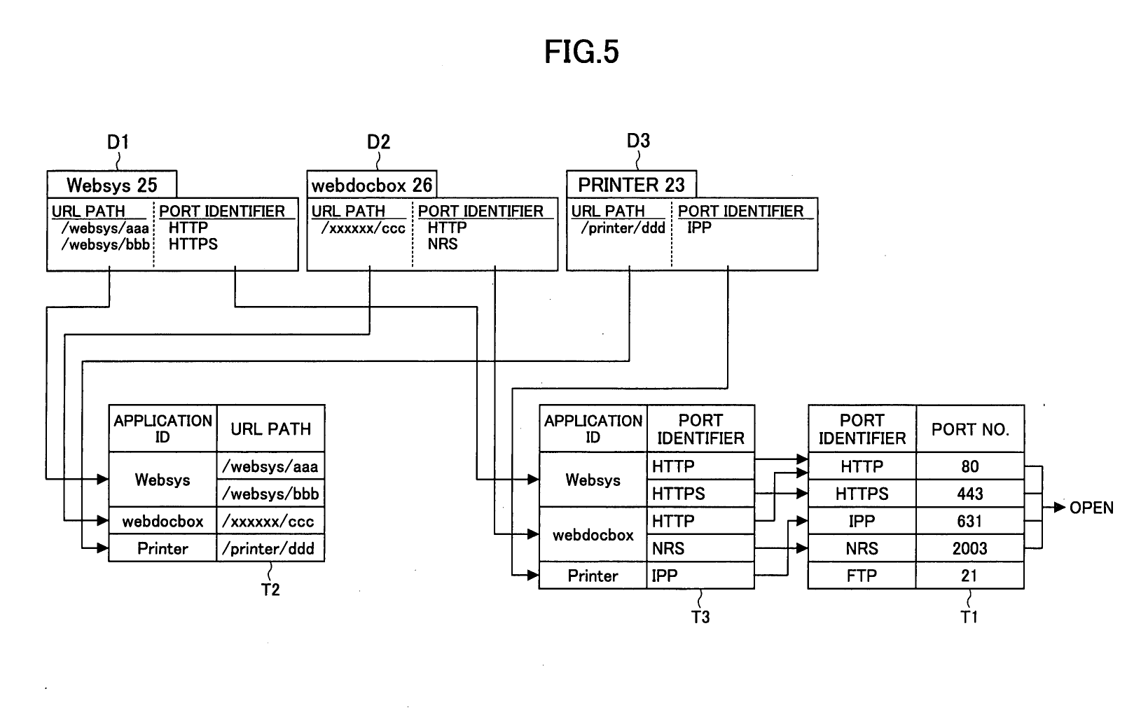

FIG. 5 is a diagram showing the relationship between a request from the application and data to be recorded in the tables in the above-described port recording operation.

Referring to FIG. 5, when requests D1, D2, and D3 are made in sequence by the Web application (Websys) 25, the Web application (webdocbox) 26, and the printer application 23, respectively, data are recorded in the application ID and URL path correspondence table T2 and the application ID and port identifier correspondence table T3 according to the operation procedure shown in FIG. 4. That is, for instance, with respect to the request D1, an application ID “Websys” identifying the requesting application 25 and each of specified URL paths “/websys/aaa” and “/websys/bbb” are correlated with each other and recorded in the application ID and URL path correspondence table T2. Further, the application ID “Websys” and each of specified port identifiers “HTTP” and “HTTPS” are correlated with each other and recorded in the application ID and port identifier correspondence table T3.

When recording of data in the application ID and port identifier correspondence table T3 is completed with respect to each of the requests D1 through D3, corresponding ports are opened through reference to the port identifier and port number correspondence table T1.

Thus, only a port whose recording is requested after activation of the image-forming apparatus 1 may be recorded and dynamically opened. Accordingly, it is possible to prevent a port corresponding to a service not in use from being opened improperly. As a result, illegal access can be reduced so that security can be increased.

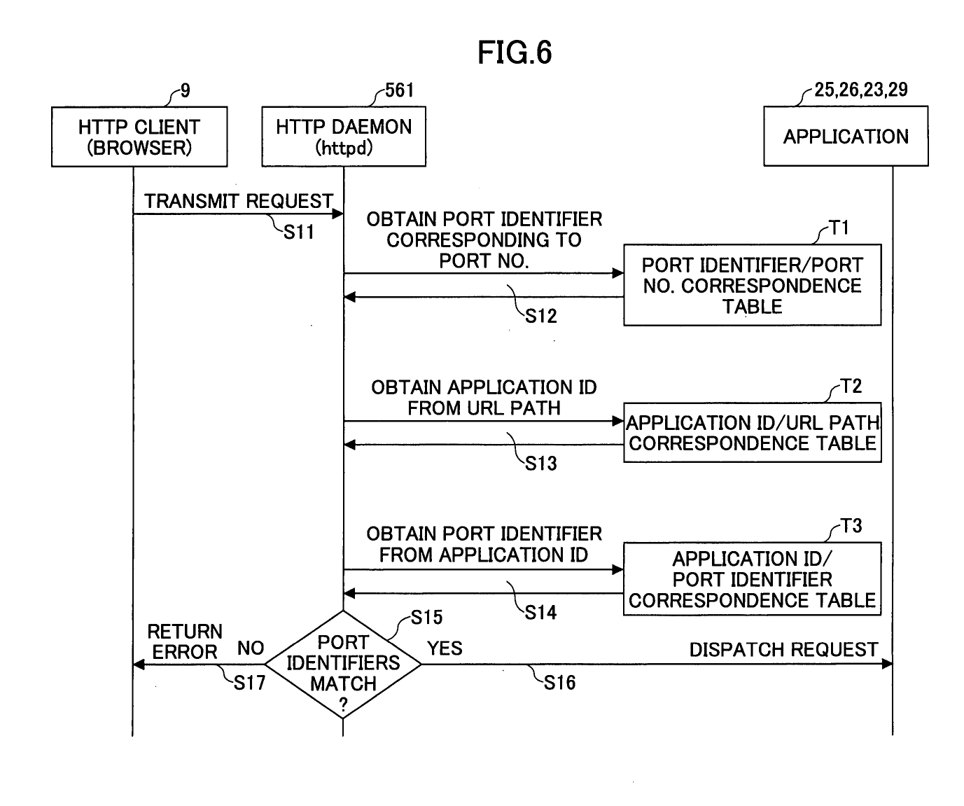

FIG. 6 is a sequence diagram showing an operation procedure at the time of request reception.

In step S11 of FIG. 6, the HTTP client 9 makes (transmits) a request via the network. Then, the HTTP daemon 561 of the NCS 56 receives the request.

In step S12, recognizing a port number that has received the request, the request processing part 563 of the HTTP daemon 561 refers to the port identifier and port number correspondence table T1, and obtains the port identifier corresponding to the port number.

Then, in step S13, recognizing a URL path specified by the request, the request processing part 563 of the HTTP daemon 561 refers to the application ID and URL path correspondence table T2, and obtains the application ID corresponding to the URL path.

Next, in step S14, based on the obtained application ID, the request processing part 563 of the HTTP daemon 561 refers to the application ID and port identifier correspondence table T3, and obtains a port identifier corresponding to the application ID.

Then, in step S15, the request processing part 563 of the HTTP daemon 561 compares the port identifier obtained in step S12 and the port identifier obtained in step S14, and determines whether the port identifier obtained in step S12 and the port identifier obtained in step S14 match. If the port identifiers match (that is, YES in step S15), in step S16, the request processing part 563 of the HTTP daemon 561 dispatches the request to an application specified by the URL path. If the port identifiers do not match (that is, NO in step S15), in step S17, the request processing part 563 of the HTTP daemon 561 returns an error to the HTTP client 9.

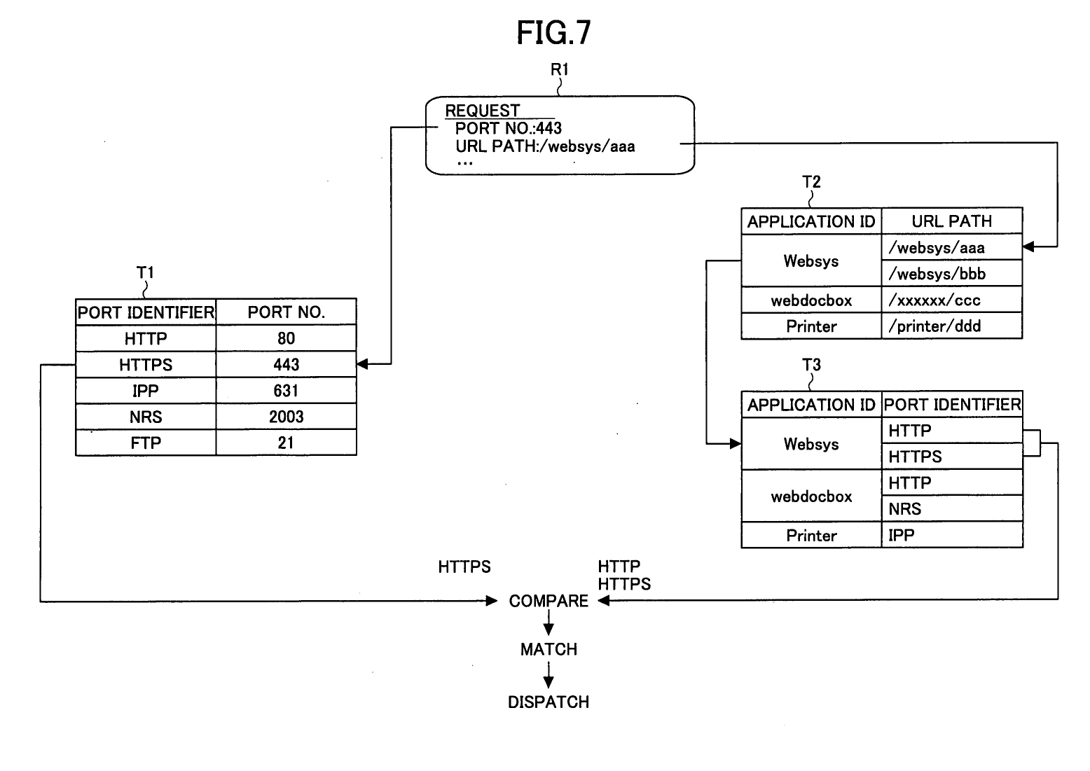

FIG. 7 is a diagram showing the relationship between a request and table contents in the above-described port verifying operation at the time of request reception.

Referring to FIG. 7, when a received request R1 specifies a port number “443” and a URL path “/websys/aaa,” a port identifier “HTTPS” is obtained from the port number “443” of the request R1 by reference to the port identifier and port number correspondence table T1 according to the operation procedure shown in FIG. 6. On the other hand, an application ID “Websys” is obtained from the URL path “/websys/aaa” of the request R1 by reference to the application ID and URL path correspondence table T2. Based on the application ID “Websys,” port identifiers “HTTP” and “HTTPS” are obtained by reference to the application ID and port identifier correspondence table T3.

The port identifier “HTTPS” obtained from the table 1 and the port identifiers “HTTP” and “HTTPS” obtained from the table 3 are compared. In this comparison, matching is determined based on whether there is a port identifier common to the port identifier obtained from the port number of the request R1 and the port identifiers obtained from the URL path of the request R1. In this case, the port identifier “HTTPS” is a common port identifier. Accordingly, it is determined that there is a match between the port identifier obtained from the port number of the request R1 and the port identifiers obtained from the URL path of the request R1. As a result, the request R1 is dispatched to a corresponding application.

Thus, only a request from a port pre-recorded by an application may be dispatched thereto. Accordingly, it is possible to prevent a request from a port from which the application does not expect to receive a request from being passed to the application. As a result, security can be improved.

In this embodiment, the HTTP daemon 561 is described. However, the same applies to other protocol daemons such as the FTP daemon 564 (FIG. 3). That is, by providing a port recording part, a request processing part, an application ID and URL path correspondence table, and an application ID and port identifier correspondence table in a protocol daemon, it is also possible in other protocols to prevent a request from a port from which an application does not expect to receive a request and to prevent improper opening of a port not to be used.

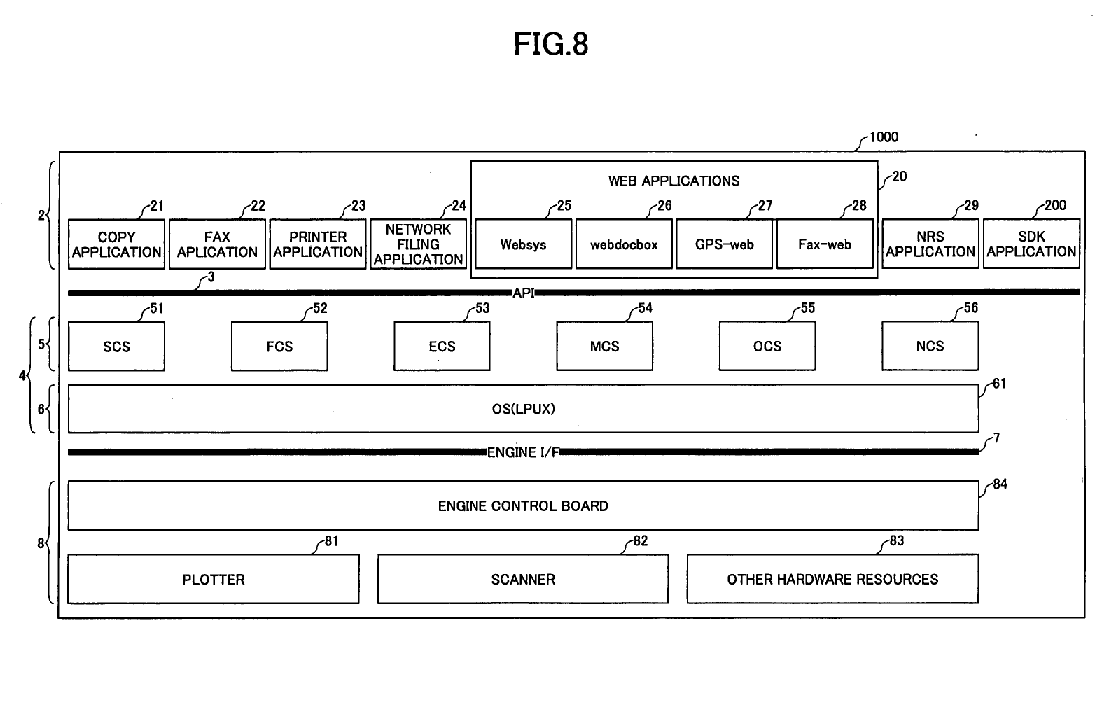

FIG. 8 is a block diagram showing a functional configuration of an image-forming apparatus (information processing apparatus) 1000 according to a second embodiment of the present invention. In the following description, the same elements as those of the first embodiment are referred to by the same numerals.

Referring to FIG. 8, the image-forming apparatus 1000 includes the application layer 2, the platform layer 4, and the engine part 8. The interface 3 is an interface (API: Application Programming Interface) with the application layer 2 provided by the platform layer 4. The interface 7 is an engine I/F between the platform layer 4 and the engine part 8.

The application layer 2 is a group of software programs performing processing individually in the image-forming apparatus 1000. The application layer 2 includes the copy application 21, the facsimile (FAX) application 22, the printer application 23, and the network filing application 24. The Web applications 20 are a group of applications performing Web services under HTTP. The Web applications 20 include the Web application (Websys) 25, the Web application (webdocbox) 26, the Web application (GPS-web) 27, and the Web application (Fax-web) 28.

The NRS application 29 provides a remote diagnosis service called NRS to a particular contract user.

Further, an SDK application 200 is an application developed by a third party, such as “document management software for a specific line of business.”

Although not graphically represented, a library (a platform) for providing common functions to the applications so as to facilitate software development is suitably provided between the applications and the interface 3.

The platform layer 4 is a group of software programs providing common service functions to the applications 21 through 29 and 200 of the application layer 2 via the interface 3. The platform layer 4 includes the service layer 5 and the OS layer 6. The service layer 5 includes the SCS 51, the FCS 52, the ECS 53, the MCS 54, the OCS 55, and the NCS 56. The OS layer 6 includes the OS (LPUX) 61.

The engine part 8 includes engines such as the plotter 81, the scanner 82, and the other hardware resources 83. Further, the engine part 8 includes the engine control board 84 controlling the engines.

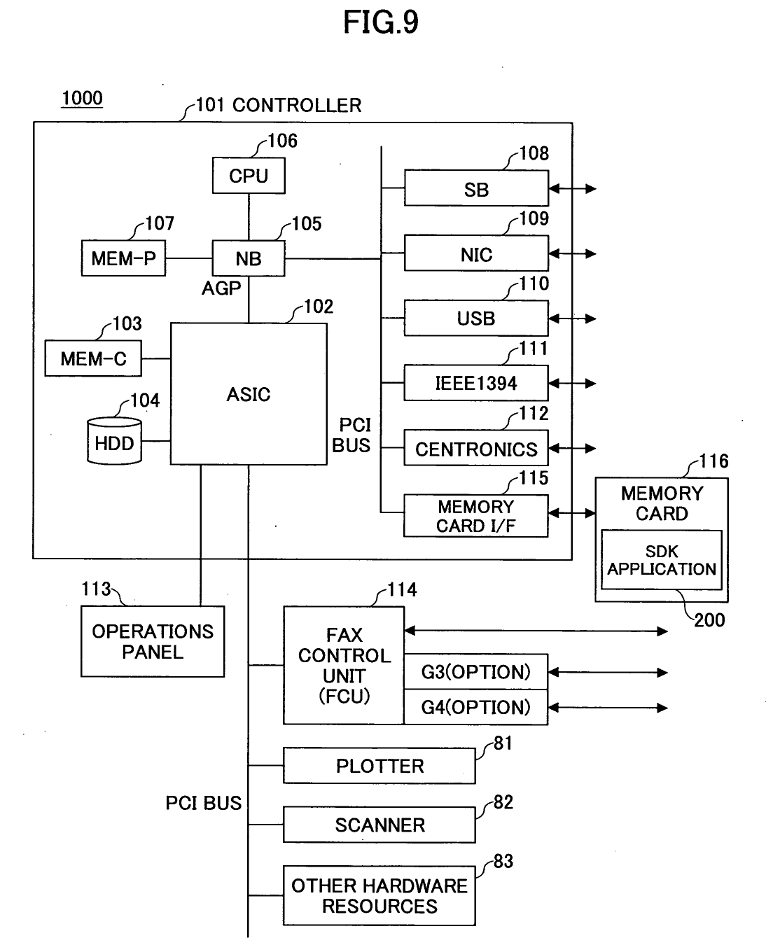

FIG. 9 is a block diagram showing a hardware configuration of the image-forming apparatus 1000.

Referring to FIG. 9, the image-forming apparatus 1000 includes the controller 101, the operations panel 113, the facsimile control unit 114, the plotter 81, the scanner 82, and the other hardware resources 83, which are electrically connected.

In the controller 101, the CPU 106 is connected via the NB 105 to the ASIC 102. The SB 108, the NIC 109, the USB 110, the IEEE 1394 device 111, the Centronics device 112, and a memory card interface (I/F) 115 are connected to the PCI BUS of the NB 105. The memory card interface 115 performs input/output operations with, or transfers programs and data to and from, a memory card 116 storing the SDK application 200. The MEM-C 103 and the HDD 104 are connected to the ASIC 102, and the MEM-P 107 is connected to the NB 105. The memory card interface 115 may use part or all of the function of the USB 110.

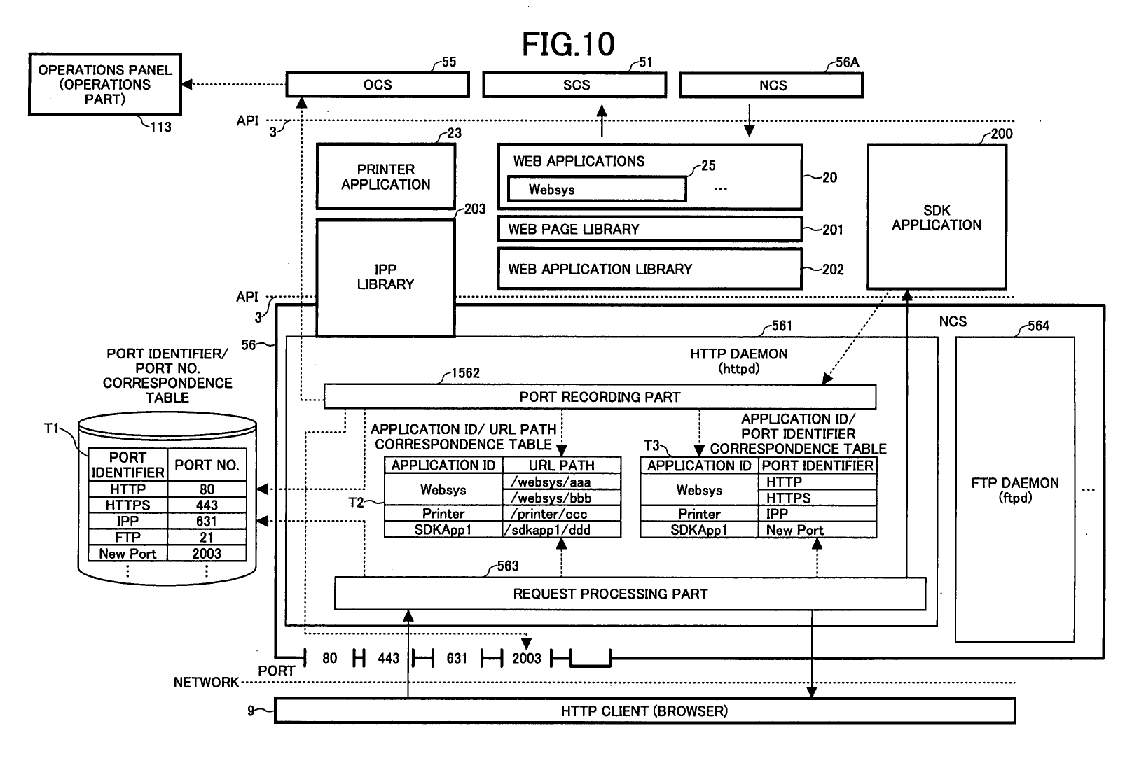

FIG. 10 is a block diagram showing a functional configuration of a network service function-related part of the image-forming apparatus 1000.

In FIG. 10, the NCS 56 is identical to that in the service layer 5 in FIG. 8, but only its internal structure related to the function of the present invention is shown. The other structure of the NCS 56 is shown separately at the top of FIG. 10 as the NCS 56A, which is integrated with the NCS 56.

The SDK application is provided to the NCS 56 via the interface 3.

The Web applications 20 including the Web application (Websys) 25 are provided to the NCS 56 via the interface 3 with the Web page library 201 and the Web application library 202 being provided between the Web applications 20 and the NCS 56.

The NCS 56 includes the HTTP daemon 561 and the FTP daemon 564. The printer application 23 is provided to the HTTP daemon 561 via the IPP library 203. A job is passed directly from the HTTP daemon 561 to the printer application 23 via the IPP library 203.

The HTTP client 9 issues a request and receives a response via a network. Normally, the HTTP client 9 is a Web browser that operates on a personal computer.

Next, a description is given of the internal structure of the HTTP daemon 561. The HTTP daemon 561 includes a port recording part 1562, the request processing part 563, the application ID and URL path correspondence table T2, and the application ID and port identifier correspondence table T3. The port recording part 1562 records a new port based on a request from the applications (for instance, the applications 23, 25, and 200), and records ports receiving processing so that each port is correlated with a corresponding one of the applications. The request processing part 563, when receiving a request from the HTTP client 9 via a network, obtains the port corresponding to an application (corresponding to the request), and determines whether the obtained port matches the port of the request. The request processing part 563 dispatches (processing of) the request to the application only when the obtained port matches the port of the request. The application ID and URL path correspondence table T2 manages application IDs identifying the applications and URL paths by correlating the application IDs with their corresponding URL paths. The application ID and port identifier correspondence table T3 manages the application IDs and port identifiers by correlating the application IDs with their corresponding port identifiers.

The application ID and URL path correspondence table T2 and the application ID and port identifier correspondence table T3 are provided in a memory managed by the HTTP daemon 561. This is because the data of the tables T2 and T3 are not used by the other processes and proper management of the data is required to ensure security. In a state immediately after activation of the image-forming apparatus 1000, no data is recorded in the application ID and URL path correspondence table T2 and the application ID and port identifier correspondence table T3. Data is recorded therein by the subsequent operation of the port recording part 1562.

A request to display a message is transmitted from the port recording part 1562 of the HTTP daemon 561 to the OCS 55, to which the operations panel 113 is connected.

On the other hand, the port identifier and port number correspondence table T1 managing the port identifiers and actual port numbers by correlating the port identifiers with their corresponding actual port numbers is provided external to the NCS 56. The port identifier and port number correspondence table T1 is stored in, for instance, a hard disk unit as a file. After activation of the image-forming apparatus 1000, the port identifier and port number correspondence table T1 is copied into a memory and used. This is because the port identifier and port number correspondence table T1 merely shows the correspondence between the port identifiers and the port numbers and the data of the table T1 may be referred to by other processes such as the FTP daemon 564. The port identifiers and the port numbers are pre-recorded in the port identifier and port number correspondence table T1 by, for instance, a manager. As described below, the port identifiers and the port numbers are also recordable from the application side.

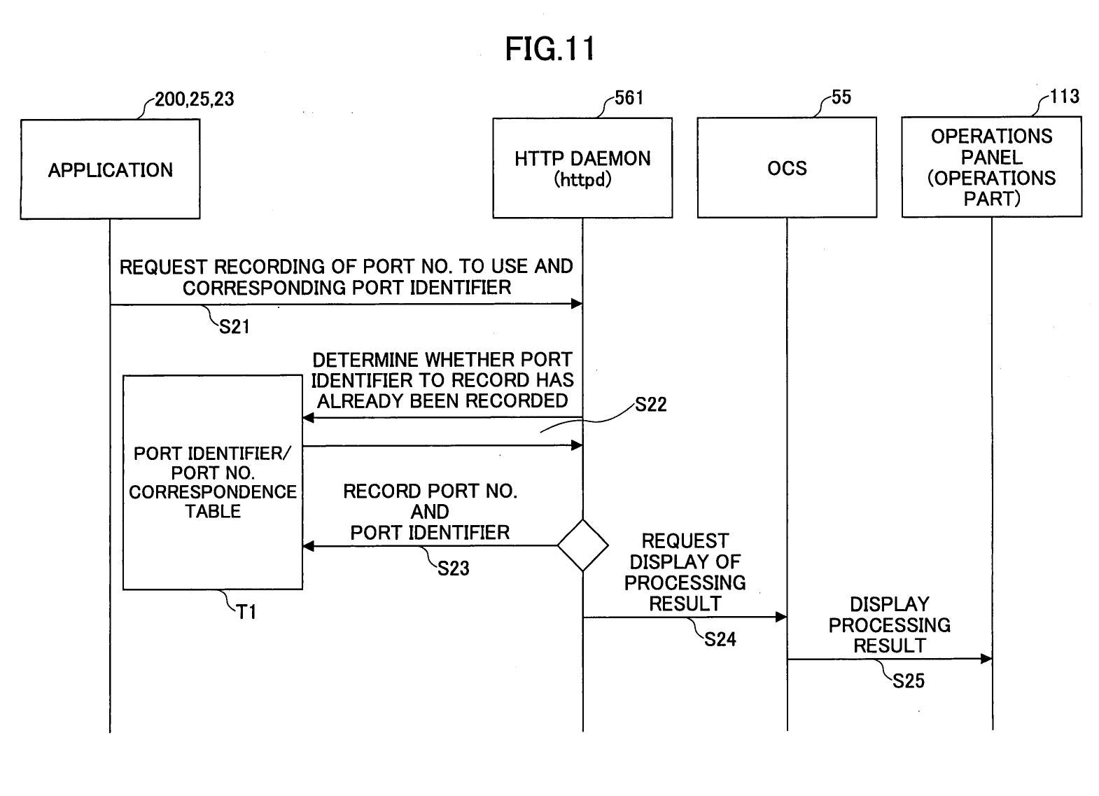

FIG. 11 is a sequence diagram showing a procedure for a port identifier and port number recording operation.

A description is given below, with reference to FIG. 11, of the procedure for the port identifier and port number recording operation.

First, in step S21 of FIG. 11, at any time point after activation of the image-forming apparatus 1000, one of the applications, such as the application 23, 25, or 200, requests the HTTP daemon 561 to record a port number to be used by the application and a corresponding port identifier. Then, in step S22, the port recording part 1562 of the HTTP daemon 561 determines, referring to the port identifier and port number correspondence table T1, whether the port identifier that the HTTP daemon 561 is requested to record has already been recorded.

If the port identifier is not recorded, in step S23, the port recording part 1562 of the HTTP daemon 561 records the port number and the corresponding port identifier in the port identifier and port number correspondence table T1, correlating the port number and the corresponding port identifier with each other. If the port identifier has already been recorded, the port identifier is not recorded redundantly.

Thereafter, in step S24, the port recording part 1562 of the HTTP daemon 561 requests the OCS 55 to display a processing result, and in step S25, the OCS 55 controls the operations panel 113 and displays the processing result.

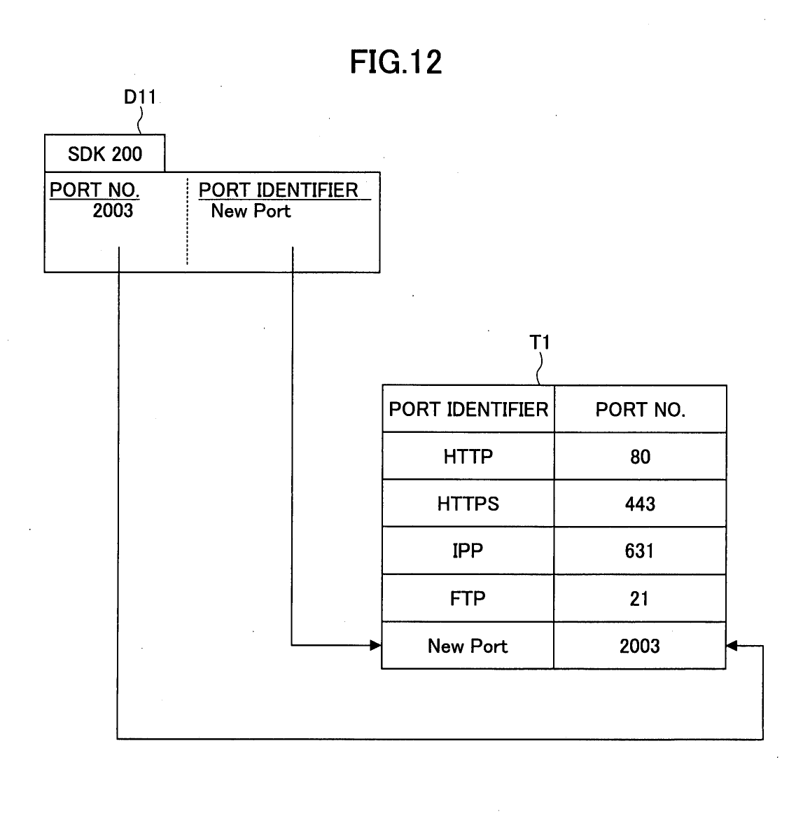

FIG. 12 is a diagram showing the relationship between a request from the application and data to be recorded in the table in the above-described port identifier and port number recording operation. Referring to FIG. 12, the SDK application 200 makes a request D11 to record port number “2003” and port identifier “New Port.” Port number “2003” and port identifier “New Port” are recorded as a new port in the port identifier and port number correspondence table T1.

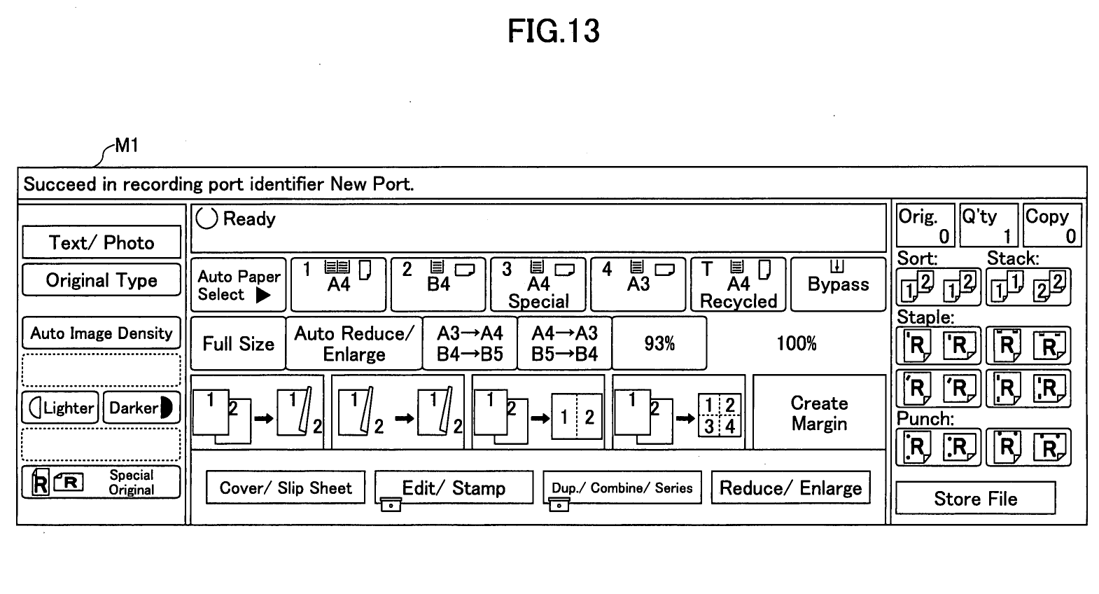

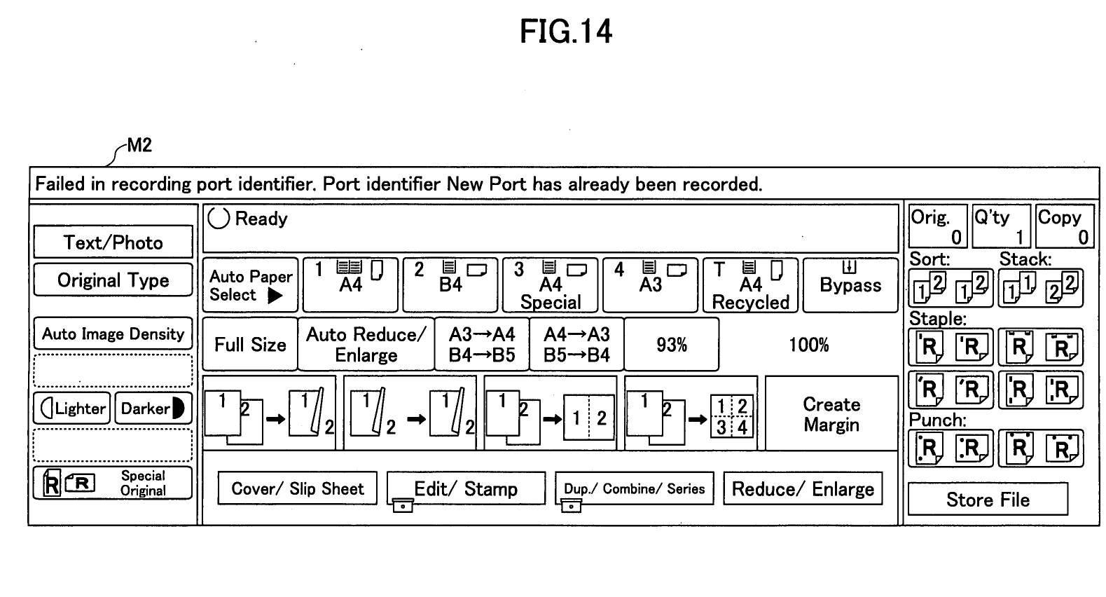

FIGS. 13 and 14 are diagrams showing example messages on the operations panel 113 in the above-described port identifier and port number recording operation. That is, when recording of the port identifier and the port number succeeds, a message M1 “Succeeded in recording port identifier New Port” is displayed as a line message at the top of the screen as shown in FIG. 13. When recording of the port identifier and the port number fails, a message M2 “Failed in recording port identifier. Port identifier New Port has already been recorded” is displayed as a line message at the top of the screen as shown in FIG. 14. Here, a line message refers to a simplified message that is shown, for instance, for an error that is not fatal to the image-forming apparatus 1000. Thus, after processing for recording the port identifier and the port number, the result of the processing is displayed on the operations panel 113. As a result, it is clarified whether settings are provided properly at the time of introducing the SDK application 200.

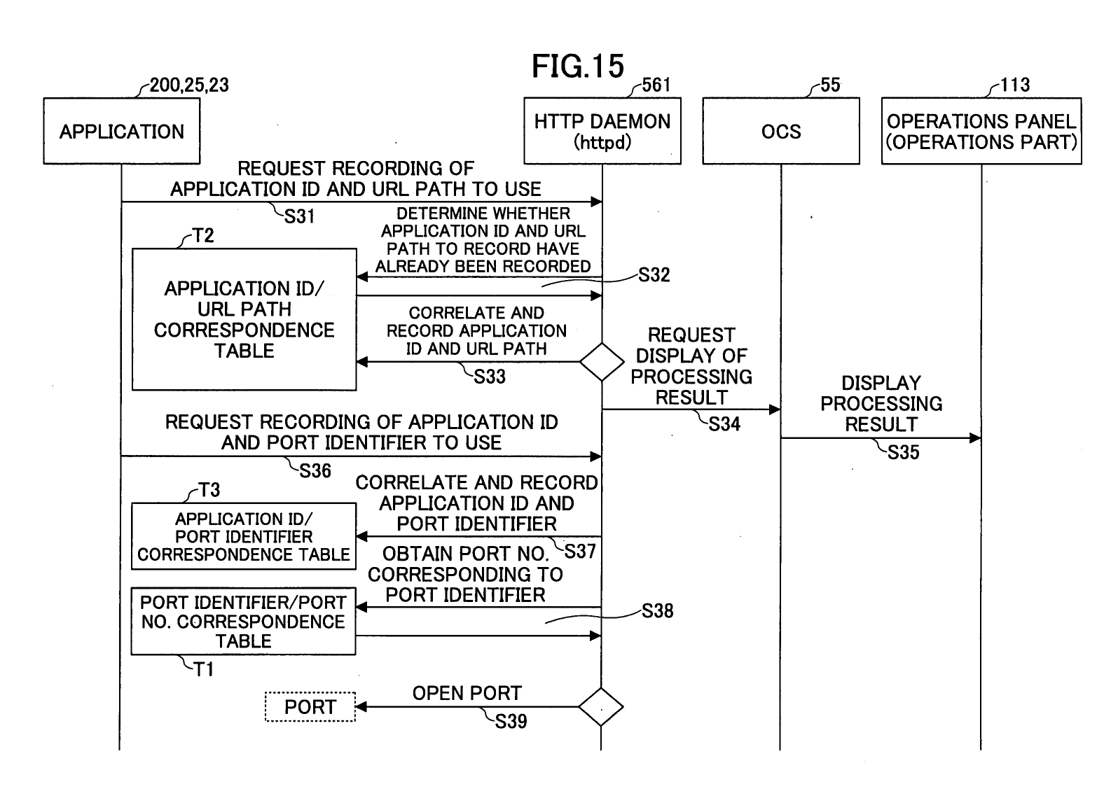

FIG. 15 is a sequence diagram showing a procedure for an application ID/URL path and application ID/port identifier recording operation.

A description is given below, with reference to FIG. 15, of the application ID/URL path and application ID/port identifier recording operation.

First, in step S31 of FIG. 15, at any time point after activation of the image-forming apparatus 1000, one of the applications, such as the application 23, 25, or 200, makes a request to the HTTP daemon 561 for recording of a URL path to be used by the application, the request being accompanied by an application ID identifying the application. Then, in step S32, the port recording part 1562 of the HTTP daemon 561 determines, referring to the application ID and URL path correspondence table T2, whether the combination of the application ID and the URL path that the HTTP daemon 561 is requested to record has already been recorded.

If the application ID and the URL path are not recorded, in step S33, the port recording part 1562 of the HTTP daemon 561 records the application ID and the URL path of the request in the application ID and URL path correspondence table T2, correlating the application ID and the URL path with each other. If the application ID and the URL path have already been recorded, the application ID and the URL path are not recorded redundantly.

Thereafter, in step S34, the port recording part 1562 of the HTTP daemon 561 requests the OCS 55 to display a processing result, and in step S35, the OCS 55 controls the operations panel 113 and displays the processing result.

Next, in step S36, the application requests the HTTP daemon 561 to record a port identifier corresponding to a port through which the application authorizes a request to access the application. Then, in step S37, the port recording part 1562 of the HTTP daemon 561 records the application ID identifying the requesting application and the specified port identifier in the application ID and port identifier correspondence table T3, correlating the application ID and the specified port identifier with each other.

Next, in step S38, the port recording part 1562 of the HTTP daemon 561 refers to the port identifier and port number correspondence table T1, and obtains the port number corresponding to the recorded port identifier. Then, in step S39, the port recording part 1562 determines whether the port of the port number is open, and if the port is not open (that is, closed), the port recording part 1562 dynamically opens the port.

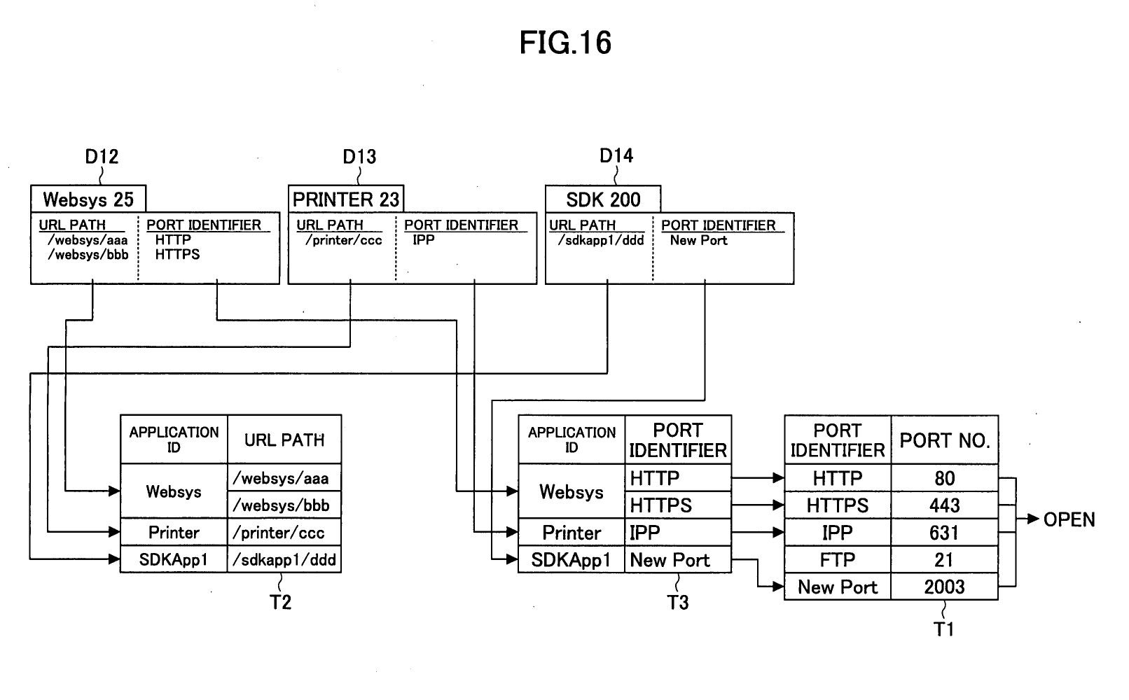

FIG. 16 is a diagram showing the relationship between a request from the application and data to be recorded in the tables in the above-described application ID/URL path and application ID/port identifier recording operation.

Referring to FIG. 16, when requests D12, D13, and D14 are made in sequence by the Web application (Websys) 25, the printer application 23, and the SDK application 200, respectively, data are recorded in the application ID and URL path correspondence table T2 and the application ID and port identifier correspondence table T3 according to the operation procedure shown in FIG. 15. That is, for instance, with respect to the request D12, an application ID “Websys” identifying the requesting application 25 and each of specified URL paths “/websys/aaa” and “/websys/bbb” are correlated with each other and recorded in the application ID and URL path correspondence table T2. Further, the application ID “Websys” and each of specified port identifiers “HTTP” and “HTTPS” are correlated with each other and recorded in the application ID and port identifier correspondence table T3.

When recording of data in the application ID and port identifier correspondence table T3 is completed with respect to each of the requests D12 through D14, corresponding ports are opened through reference to the port identifier and port number correspondence table T1.

Thus, only a port whose recording is requested after activation of the image-forming apparatus 1000 may be recorded and dynamically opened. Accordingly, it is possible to prevent a port corresponding to a service not in use from being opened improperly. As a result, illegal access can be reduced so that security can be increased.

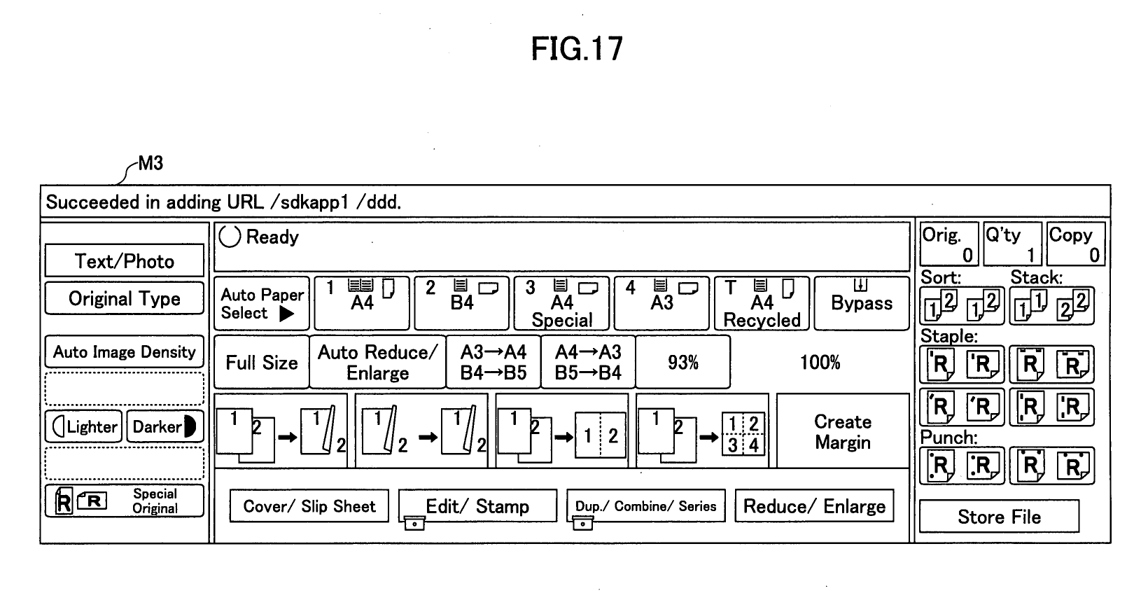

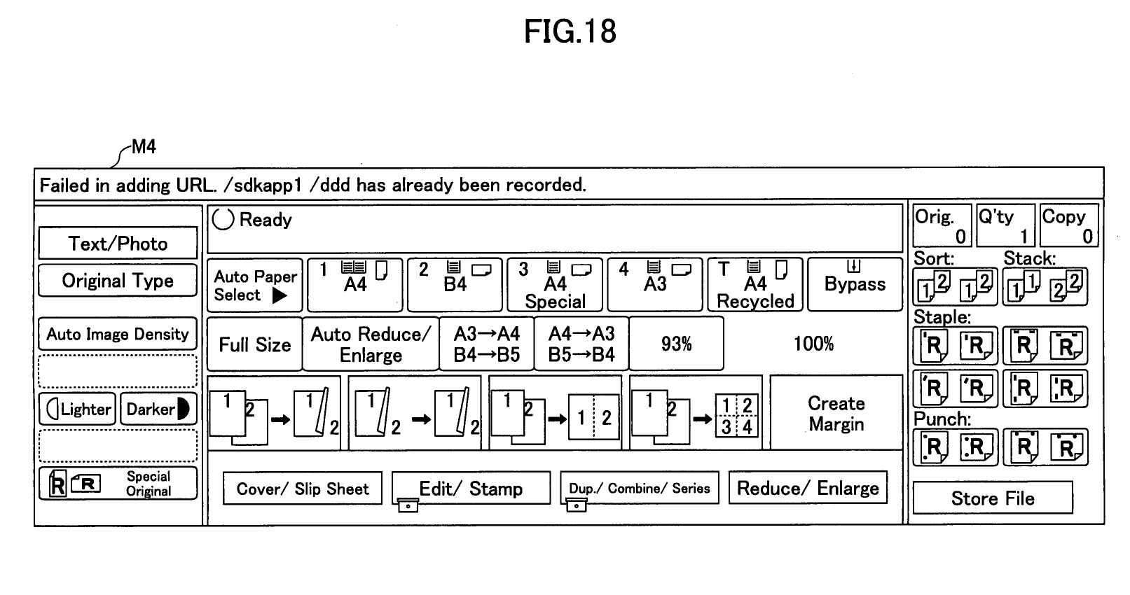

FIGS. 17 and 18 are diagrams showing example messages on the operations panel 113 in the above-described recording of the application ID and the URL path. That is, when recording of the application ID and the URL path succeeds, a message M3 “Succeeded in adding URL /sdkapp1/ddd” is displayed as a line message at the top of the screen as shown in FIG. 17. When recording of the application ID and the URL path fails, a message M4 “Failed in adding URL. /sdkapp1/ddd has already been recorded” is displayed as a line message at the top of the screen as shown in FIG. 18.

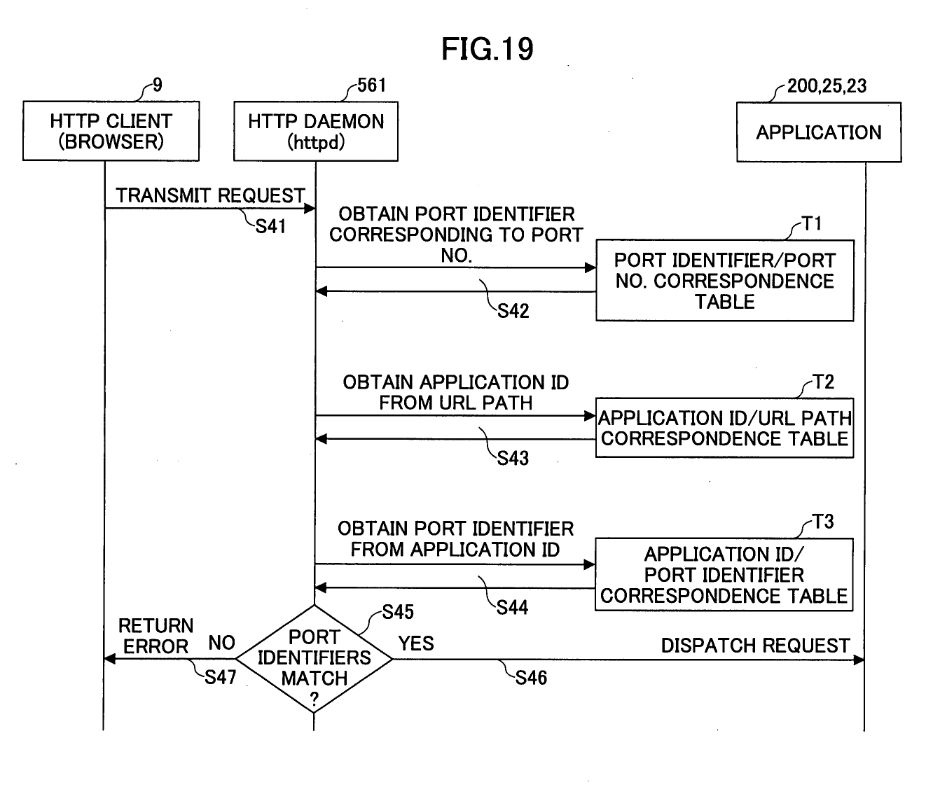

FIG. 19 is a sequence diagram showing an operation procedure at the time of request reception.

In step S41 of FIG. 19, the HTTP client 9 makes (transmits) a request via the network. Then, the HTTP daemon 561 of the NCS 56 receives the request.

In step S42, recognizing a port number that has received the request, the request processing part 563 of the HTTP daemon 561 refers to the port identifier and port number correspondence table T1, and obtains the port identifier corresponding to the port number.

Then, in step S43, recognizing a URL path specified by the request, the request processing part 563 of the HTTP daemon 561 refers to the application ID and URL path correspondence table T2, and obtains the application ID corresponding to the URL path.

Next, in step S44, based on the obtained application ID, the request processing part 563 of the HTTP daemon 561 refers to the application ID and port identifier correspondence table T3, and obtains a port identifier corresponding to the application ID.

Then, in step S45, the request processing part 563 of the HTTP daemon 561 compares the port identifier obtained in step S42 and the port identifier obtained in step S44, and determines whether the port identifier obtained in step S42 and the port identifier obtained in step S44 match. If the port identifiers match (that is, YES in step S45), in step S46, the request processing part 563 of the HTTP daemon 561 dispatches the request to an application specified by the URL path. If the port identifiers do not match (that is, NO in step S45), in step S47, the request processing part 563 of the HTTP daemon 561 returns an error to the HTTP client 9.

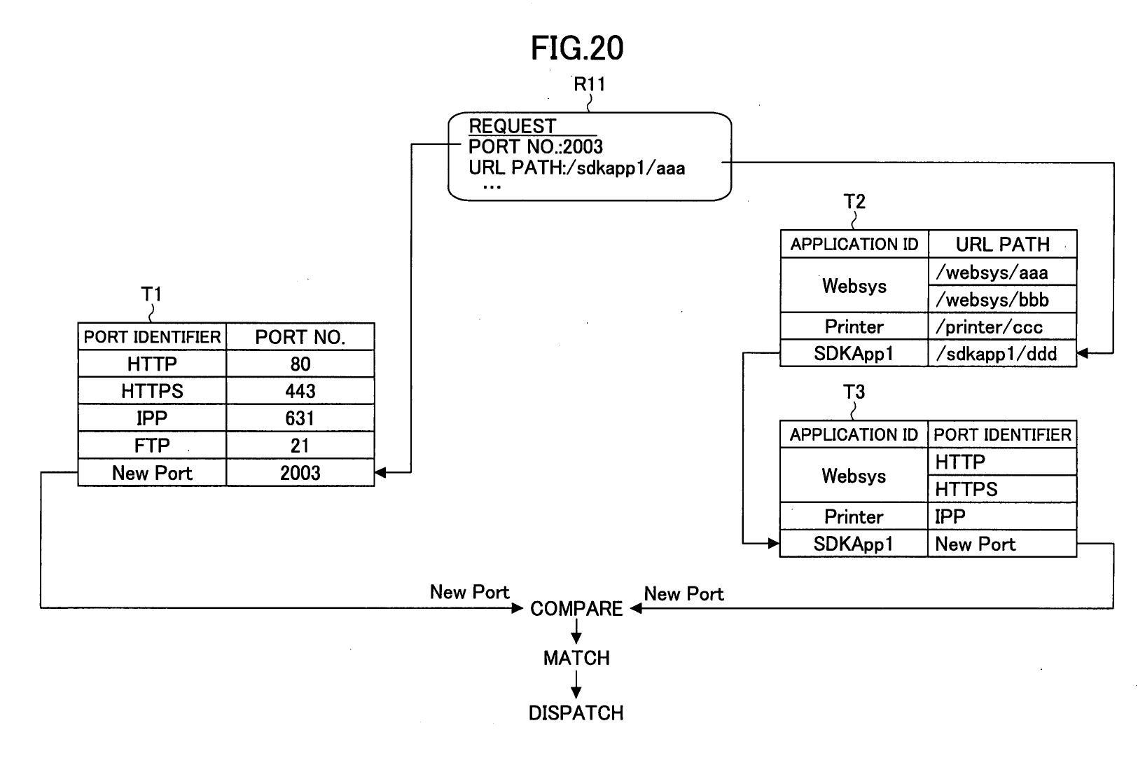

FIG. 20 is a diagram showing the relationship between a request and table contents in the above-described port verifying operation at the time of request reception.

Referring to FIG. 20, when a received request R11 specifies a port number “2003” and a URL path “/sdkapp1/aaa,” a port identifier “New Port” is obtained from the port number “2003” of the request R11 by reference to the port identifier and port number correspondence table T1 according to the operation procedure shown in FIG. 19. On the other hand, an application ID “SDKApp1” is obtained from the URL path “/sdkapp1/aaa” of the request R11 by reference to the application ID and URL path correspondence table T2. Based on the application ID “SDKApp1,” a port identifier “New Port” is obtained by reference to the application ID and port identifier correspondence table T3.

The port identifier “New Port” obtained from the table 1 and the port identifier “New Port” obtained from the table 3 are compared. Here, both port identifiers are the same (New Port). Accordingly, it is determined that the port identifiers match, and the request R11 is dispatched to a corresponding application. In this comparison, matching is determined based on whether there is a port identifier common to the port identifier obtained from the port number of the request R11 and the port identifier obtained from the URL path of the request R1. Therefore, even in the case where multiple port identifiers are obtained from the application ID and port identifier correspondence table T3, if there is a port identifier common to the port identifier obtained from the table 1 and the multiple port identifiers obtained from the table 3, it is determined that there is a match between the port identifier obtained from the table 1 and the multiple port identifiers obtained from the table 3.

Thus, only a request from a port pre-recorded by an application may be dispatched thereto. Accordingly, it is possible to prevent a request from a port from which the application does not expect to receive a request from being passed to the application. As a result, security can be improved.

In this embodiment, the HTTP daemon 561 is described. However, the same applies to other protocol daemons such as the FTP daemon 564 (FIG. 10). That is, by providing a port recording part, a request processing part, an application ID and URL path correspondence table, and an application ID and port identifier correspondence table in a protocol daemon, it is also possible in other protocols to prevent a request from a port from which an application does not expect to receive a request and to prevent improper opening of a port not to be used.

Thus, according to the present invention, a request from a port from which an application does not expect to receive a request is prevented from being passed to the application, and a port not to be used is prevented from being opened improperly. As a result, security can be improved in port access. Further, a port receiving processing is recorded application by application. Therefore, there is more flexibility in port selection on the application side. Further, by performing port management introducing the concept of port identifier, it is possible to make a response easily in the case of, for instance, changing port numbers simultaneously.

Further, according to the present invention, a port receiving processing can be recorded optionally from the SDK application side. Accordingly, there is more flexibility in port selection on the application side. Further, a request from a port from which an application does not expect to receive a request is prevented from being passed to the application, and a port not to be used is prevented from being opened improperly. As a result, security can be improved in port access.

Further, according to the present invention, the port recording part (562, 1562) performs port recording using the application ID and URL path correspondence table T2 and the application ID and port identifier correspondence table T3. Accordingly, data can be properly managed.

Further, according to the present invention, in recording the applications and the ports so that each application is correlated with a corresponding one or more of the ports for receiving a request to the application, the port recording part (562, 1562) records a URL path with respect to each application, the URL path being used for dispatching the request to the application. Accordingly, the applications can make requests successively in a uniform manner.

The present invention is not limited to the specifically disclosed embodiments, and variations and modifications may be made without departing from the scope of the present invention.

The present application is based on Japanese Priority Patent Application Nos. 2003-323538 and 2003-323539, both filed on Sep. 16, 2003, the entire contents of which are hereby incorporated by reference.

1. An information processing apparatus having a network service function that receives incoming requests through a plurality of ports by a protocol daemon, and dispatches processing of each incoming request to one of applications identified by information included in the incoming request, the information processing apparatus comprising:
a request processing part configured to, when each incoming request is received, obtain a port corresponding to the identified application, determine whether the obtained port matches a port of the incoming request, and dispatch the processing of the incoming request to the identified application when the obtained port matches the port of the incoming request.

2. The information processing apparatus as claimed in claim 1, further comprising:
a port recording part configured to record the applications and the ports so that each application is correlated with a corresponding one or more of the ports for receiving the incoming request to the application.

3. The information processing apparatus as claimed in claim 2, wherein the port recording part records the corresponding one or more of the ports with respect to each application based on a request from the application after activation of the information processing apparatus, and dynamically opens the recorded ports.

4. The information processing apparatus as claimed in claim 2, wherein the port recording part and the request processing part use port identifiers to distinguish the ports, each port identifier uniquely identifying a corresponding one of the ports.

5. The information processing apparatus as claimed in claim 4, wherein the port recording part records the corresponding one or more of the ports with respect to each application using an application ID and port identifier correspondence table where application IDs identifying the applications and the corresponding port identifiers are correlated with each other and managed.

6. The information processing apparatus as claimed in claim 5, wherein the application ID and port identifier correspondence table is managed under the protocol daemon.

7. The information processing apparatus as claimed in claim 4, wherein:
the request processing part obtains a first port identifier corresponding to a port number of the incoming request from a port identifier and port number correspondence table where the port identifiers and corresponding actual port numbers are correlated with each other and managed;
the request processing part obtains one of application IDs corresponding to a URL path of the incoming request from an application ID and URL path correspondence table where the application IDs identifying the applications and corresponding URL paths are correlated with each other and managed;
the request processing part obtains a second port identifier corresponding to the one of the application IDs corresponding to the URL path of the incoming request from an application ID and port identifier correspondence table where the application IDs and the corresponding port identifiers are correlated with each other and managed; and
the request processing part determines, by comparing the first and second port identifiers, whether the port of the incoming request and the port corresponding to the application match.

8. The information processing apparatus as claimed in claim 7, wherein the port identifier and port number correspondence table is managed independent of the protocol daemon.

9. The information processing apparatus as claimed in claim 7, wherein the application ID and port identifier correspondence table is managed under the protocol daemon.

10. The information processing apparatus as claimed in claim 7, wherein the application ID and URL path correspondence table is managed under the protocol daemon.

11. The information processing apparatus as claimed in claim 2, wherein in recording the applications and the ports so that each application is correlated with the corresponding one or more of the ports, the port recording part records a URL path with respect to each application, the URL path being used to dispatch the incoming request to the application.

12. The information processing apparatus as claimed in claim 11, wherein the port recording part records the URL path with respect to each application using an application ID and URL path correspondence table where application IDs identifying the applications and the corresponding URL paths are correlated with each other and managed.

13. The information processing apparatus as claimed in claim 12, wherein the application ID and URL path correspondence table is managed under the protocol daemon.

14. The information processing apparatus as claimed in claim 11, wherein:
the request processing part obtains a first port identifier corresponding to a port number of the incoming request from a port identifier and port number correspondence table where the port identifiers and corresponding actual port numbers are correlated with each other and managed;
the request processing part obtains one of application IDs corresponding to a URL path of the incoming request from an application ID and URL path correspondence table where the application IDs identifying the applications and the corresponding URL paths are correlated with each other and managed;
the request processing part obtains a second port identifier corresponding to the one of the application IDs corresponding to the URL path of the incoming request from an application ID and port identifier correspondence table where the application IDs and the corresponding port identifiers are correlated with each other and managed; and
the request processing part determines, by comparing the first and second port identifiers, whether the port of the incoming request and the port corresponding to the application match.

15. The information processing apparatus as claimed in claim 14, wherein the port identifier and port number correspondence table is managed independent of the protocol daemon.

16. The information processing apparatus as claimed in claim 14, wherein the application ID and port identifier correspondence table is managed under the protocol daemon.

17. The information processing apparatus as claimed in claim 14, wherein the application ID and URL path correspondence table is managed under the protocol daemon.

18. The information processing apparatus as claimed in claim 1, wherein the protocol daemon is an HTTP daemon.

19. A network service providing method of an information processing apparatus that receives incoming requests through a plurality of ports by a protocol daemon, and dispatches processing of each incoming request to one of applications identified by information included in the incoming request, the network service providing method comprising the steps of:
(a) recording the applications and the ports so that each application is correlated with a corresponding one or more of the ports for receiving the incoming request to the application; and
(b) when each incoming request is received, obtaining the one or more of the ports corresponding to the identified application, determining whether one of the obtained ports matches a port of the incoming request, and dispatching the processing of the incoming request to the identified application when the one of the obtained ports matches the port of the incoming request.

20. The network service providing method as claimed in claim 19, wherein said step (a) records the corresponding one or more of the ports with respect to each application based on a request from the application after activation of the information processing apparatus, and dynamically opens the recorded ports.

21. An information processing apparatus having a network service function that receives incoming requests through a plurality of ports by a protocol daemon, and dispatches processing of each incoming request to one of applications identified by information included in the incoming request, the information processing apparatus comprising:
a port recording part configured to record a new port based on a port recording request from any of the applications, and record the applications and the ports so that each application is correlated with a corresponding one or more of the ports for receiving the incoming request to the application; and
a request processing part configured to, when each incoming request is received, obtain the one or more of the ports corresponding to the identified application, determine whether one of the obtained ports matches a port of the incoming request, and dispatch the processing of the incoming request to the identified application when the one of the obtained ports matches the port of the request.

22. The information processing apparatus as claimed in claim 21, wherein the port recording part records the corresponding one or more of the ports with respect to each application based on a request from the application after activation of the information processing apparatus, and dynamically opens the recorded ports.

23. The information processing apparatus as claimed in claim 21, wherein after processing for the recording of the ports, a message showing a result of the processing is displayed on an operations panel.

24. The information processing apparatus as claimed in claim 21, wherein the port recording part and the request processing part use port identifiers to distinguish the ports.

25. The information processing apparatus as claimed in claim 24, wherein the port recording part records the ports using a port identifier and port number correspondence table where the port identifiers and corresponding actual port numbers are correlated with each other and managed, and an application ID and port identifier correspondence table where application IDs identifying the applications and the corresponding port identifiers are correlated with each other and managed.

26. The information processing apparatus as claimed in claim 25, wherein the port identifier and port number correspondence table is managed independent of the protocol daemon.

27. The information processing apparatus as claimed in claim 25, wherein the application ID and port identifier correspondence table is managed under the protocol daemon.

28. The information processing apparatus as claimed in claim 24, wherein:
the request processing part obtains a first port identifier corresponding to a port number of the incoming request from a port identifier and port number correspondence table where the port identifiers and corresponding actual port numbers are correlated with each other and managed;
the request processing part obtains one of application IDs corresponding to a URL path of the incoming request from an application ID and URL path correspondence table where the application IDs identifying the applications and corresponding URL paths are correlated with each other and managed;
the request processing part obtains a second port identifier corresponding to the one of the application IDs corresponding to the URL path of the incoming request from an application ID and port identifier correspondence table where the application IDs and the corresponding port identifiers are correlated with each other and managed; and
the request processing part determines, by comparing the first and second port identifiers, whether the port of the incoming request and the port corresponding to the application match.

29. The information processing apparatus as claimed in claim 28, wherein the port identifier and port number correspondence table is managed independent of the protocol daemon.

30. The information processing apparatus as claimed in claim 28, wherein the application ID and port identifier correspondence table is managed under the protocol daemon.

31. The information processing apparatus as claimed in claim 28, wherein the application ID and URL path correspondence table is managed under the protocol daemon.

32. The information processing apparatus as claimed in claim 21, wherein in recording the applications and the ports so that each application is correlated with the corresponding one or more of the ports, the port recording part records a URL path with respect to each application, the URL path being used to dispatch the incoming request to the application.

33. The information processing apparatus as claimed in claim 32, wherein the port recording part records the URL path with respect to each application using an application ID and URL path correspondence table where application IDs identifying the applications and the corresponding URL paths are correlated with each other and managed.

34. The information processing apparatus as claimed in claim 33, wherein the application ID and URL path correspondence table is managed under the protocol daemon.

35. The information processing apparatus as claimed in claim 32, wherein:
the request processing part obtains a first port identifier corresponding to a port number of the incoming request from a port identifier and port number correspondence table where the port identifiers and corresponding actual port numbers are correlated with each other and managed;
the request processing part obtains one of application IDs corresponding to a URL path of the incoming request from an application ID and URL path correspondence table where the application IDs identifying the applications and the corresponding URL paths are correlated with each other and managed;
the request processing part obtains a second port identifier corresponding to the one of the application IDs corresponding to the URL path of the incoming request from an application ID and port identifier correspondence table where the application IDs and the corresponding port identifiers are correlated with each other and managed; and
the request processing part determines, by comparing the first and second port identifiers, whether the port of the incoming request and the port corresponding to the application match.

36. The information processing apparatus as claimed in claim 35, wherein the port identifier and port number correspondence table is managed independent of the protocol daemon.

37. The information processing apparatus as claimed in claim 35, wherein the application ID and port identifier correspondence table is managed under the protocol daemon.

38. The information processing apparatus as claimed in claim 35, wherein the application ID and URL path correspondence table is managed under the protocol daemon.

39. The information processing apparatus as claimed in claim 21, wherein the protocol daemon is an HTTP daemon.

40. The information processing apparatus as claimed in claim 21, further comprising:
a memory card interface configured to transfer a program and data to and from a memory card storing an SDK application.

41. A network service providing method of an information processing apparatus that receives incoming requests through a plurality of ports by a protocol daemon, and dispatches processing of each incoming request to one of applications identified by information included in the incoming request, the network service providing method comprising the steps of:
(a) recording a new port based on a port recording request from any of the applications, and recording the applications and the ports so that each application is correlated with a corresponding one or more of the ports for receiving the incoming request to the application; and
(b) when each incoming request is received, obtaining the one or more of the ports corresponding to the identified application, determining whether one of the obtained ports matches a port of the incoming request, and dispatching the processing of the incoming request to the identified application when the one of the obtained ports matches the port of the incoming request.

42. The network service providing method as claimed in claim 41, wherein said step (a) records the corresponding one or more of the ports with respect to each application based on a request from the application after activation of the information processing apparatus, and dynamically opens the recorded ports.
